(19) United States
(12) Patent Application Publication
(10) Pub. No.: US 2026/0291823 A1
(43) Pub. Date: Sep. 24, 2026

(54) NF DEVICE AND SIGNALING CONTROL METHOD PERFORMED IN NF

(71) Applicant: SK TELECOM CO., LTD., Seoul (KR)

(72) Inventors: Dong Jin LEE, Seoul (KR); Hyun Jun CHOI, Seoul (KR); Hyeon Mo GU, Seoul (KR); Seong Jun LEE, Seoul (KR)

(21) Appl. No.: 19/490,888

(22) PCT Filed: Sep. 26, 2023
(86) PCT No.: PCT/KR2023/014730

§ 371 Date: Dec. 5, 2025

(30) Foreign Application Priority Data
Jun. 9, 2023 (KR) 10-2023-0074196

(51) Int. Cl. H04L 41/147; H04L 67/10

(52) U.S. Cl. CPC H04L 41/147; H04L 67/10

(57) ABSTRACT

The present invention proposes a scheme which defines a new Analytics ID for predicting an abnormal state (e.g., a signaling storm) between an NF (e.g., UENF, RANF, AMF, SMF, UPF, . . . ) and an NWDAF and, by using the defined ID, implements a communication technique between the NF and the NWDAF and between multiple NFs/NWDAFs for analyzing/predicting the abnormal state such as the signaling storm, thereby making it possible to identify and handle normal/abnormal states of the NF, a normal/abnormal operation between NFs, a signaling storm, etc.

### TECHNICAL FIELD

The present disclosure relates to a technology enabling identification of and coping with the normality/abnormality of a network function (NF) and a normal/abnormal operation between NFs.

This application claims priority to Korean Patent Application No. 10-2023-0074196, filed on Jun. 9, 2023, and the disclosure of the application is herein incorporated by reference in its entirety for all purposes.

### BACKGROUND ART

In current B5G/6G networks, a large number of network functions (NFs) exist, and a large amount of signaling occurs due to communications processed via a protocol based on an NF or a service-based interface (SBI) between NFs.

In addition, as central offices evolve into structures such as redundancy/distributed deployment currently and in the future, a much larger amount of signaling compared to the number of equipment types occurs during NF-to-NF communication in actual common B5G/6G network environments.

Meanwhile, in B5G/6G network environments, a large amount of signaling storm may occur in access and core networks due to abnormal operations of an NF, erroneous NF operations, and internal/external factors of the NF.

However, in the current B5G/6G standards, there is no method for detecting and coping with abnormal operations of an NF or between NFs or signaling storms.

In the current standards, it is assumed that an NF always operates “normally.” However, as the number of NFs increases, abnormal operations of an NF and between NFs, and signaling storms may occur due to errors, delays, BURST signaling, and the like.

That is, at present, it is impossible to determine an operation of an NF itself or whether an operation during communication between NFs is normal/abnormal, which may eventually lead to degradation in communication and quality experienced by customers. Alternatively, to prevent this, numerous resources are consumed, including a large investment cost by operators, redundancy/triple-redundancy of NF systems, and pre-/post-verification procedures (work start-up).

In fact, many current failures of NFs are mainly caused by faults, errors, or unexpected operations thereof, leading to growing concerns about the stability of the control plane (signaling) itself or the NFs themselves.

Therefore, the present disclosure proposes a new technical method enabling identification of and coping with the normality/abnormality of an NF and a normal/abnormal operation between NFs, so as to solve various problematic situations caused by the absence of measures in the current standards.

### DISCLOSURE OF INVENTION

### Technical Problem

The technical task to be achieved in the present disclosure is to implement a new technical method enabling identification of and coping with the normality/abnormality of an NF and a normal/abnormal operation between NFs.

### Solution to Problem

A network function (NF) device according to an aspect of the present disclosure includes a memory including an instruction, and a processor configured to execute the instruction to transfer information to be used for analysis to an NF (network data analytics function (NWDAF)) configured to perform an abnormal state prediction procedure through information analysis, to request a prediction result obtained by performing the abnormal state prediction procedure, wherein the processor is configured to select a particular NWDAF from among multiple NWDAFs according to the information to be transferred and transfer the information to the particular NWDAF.

Specifically, the processor may be configured to select the particular NWDAF, based on at least one of whether the information to be transferred is real-time data or non-real-time data, an estimated processing time consumed for analyzing the information, and a capacity required for analyzing the information.

Specifically, the multiple NWDAFs may include a first NWDAF close (local) to the NF device and a second NWDAF configured to perform an abnormal state prediction procedure by interworking with multiple first NWDAFs.

Specifically, the processor may be configured to, when receiving, from the particular NWDAF, a prediction result of an abnormal state prediction procedure performed through analysis of the transferred information, additionally request a prediction result from another NWDAF among the multiple NWDAFs according to the prediction result.

Specifically, the processor may be configured to perform a subsequent procedure according to the prediction result transferred from the particular NWDAF or the other NWDAF, and when performing of the subsequent procedure is determined to be impossible, re-request, from the particular NWDAF or the other NWDAF, a prediction result for performing an alternative subsequent procedure.

A network data analytics function (NWDAF) device according to an aspect of the present disclosure includes a memory including an instruction, and a processor configured to execute the instruction to derive a prediction result by performing an abnormal state prediction procedure related to a particular NF through analysis of information transferred from each NF, and transfer information to another NWDAF or request additional information from another NWDAF according to the prediction result.

Specifically, the processor may be configured to control information transfer to the other NWDAF by using, as a criterion, at least one of accuracy, impact, and urgency for the prediction result.

Specifically, the processor may be configured to, according to the prediction result, transfer information to the other NWDAF to allow the information to be used in an abnormal state prediction procedure for deriving a final prediction result for the particular NF, the abnormal state prediction procedure being performed by the other NWDAF, or according to the prediction result, request additional information from the other NWDAF, and derive a final prediction result by re-performing the abnormal state prediction procedure in which even the additional information is analyzed.

Specifically, the other NWDAF may be a central NWDAF configured to perform an abnormal state prediction procedure by interworking with multiple local NWDAFs.

A signaling control method performed in a network function (NF) according to an aspect of the present disclosure may include transferring information to be used for analysis to an NF (network data analytics function (NWDAF)) configured to perform an abnormal state prediction procedure through information analysis, to request a prediction result obtained by performing the abnormal state prediction procedure, wherein the transferring includes selecting a particular NWDAF from among multiple NWDAFs according to the information to be transferred and transferring the information to the particular NWDAF.

A signaling control method performed in a network data analytics function (NWDAF) according to an aspect of the present disclosure includes deriving a prediction result by performing an abnormal state prediction procedure related to a particular NF through analysis of information transferred from each NF, and transferring information to another NWDAF or requesting additional information from another NWDAF according to the prediction result.

### Advantageous Effects of Invention

According to an NF device and a signaling control method performed in an NF according to the present disclosure, a specific technical configuration enabling identification of the normality/abnormality of an NF and a normal/abnormal operation between NFs and adaptively coping therewith is implemented.

Accordingly, in the present disclosure, an effect of enabling detection of the abnormality of an NF, abnormal operations between NFs, and signaling storms, and optimally coping therewith, and an effect of avoiding degradation in communication and quality experienced by customers, which may be caused thereby, are derived.

### BRIEF DESCRIPTION OF DRAWINGS

FIG. 1 is an example diagram illustrating an example of a problematic situation in which signaling storms occur;

FIG. 2 is an example diagram illustrating core features and multiple NFs/NWDAFs to which the present disclosure is applicable;

FIG. 3 and FIG. 4 are block diagrams showing configurations of an NF device and an NWDAF device according to an embodiment of the present disclosure;

FIG. 5 is an example diagram illustrating communication content between an NF and an NWDAF in the present disclosure;

FIG. 6 to FIG. 10 are embodiments each showing a call flow proceeding according to a signaling control method performed in an NF of the present disclosure; and

FIG. 11 to FIG. 16 are embodiments each showing a call flow, depending on a signaling storm state, proceeding according to a signaling control method performed in an NF of the present disclosure.

### MODE FOR CARRYING OUT THE INVENTION

Hereinafter, various embodiments of the present disclosure will be described with reference to the accompanying drawings.

The present disclosure relates to a technology enabling identification of and coping with the normality/abnormality of a network function (NF) and a normal/abnormal operation between NFs.

In 5G, a network structure for supporting a terminal, a base station (access), a core, and a server in an end-to-end way is defined. Unlike LTE (4G), where a single node (e.g., S-GW, P-GW, etc.) performs functions of control signaling and data transmission and reception in a combined manner, the network structure is defined to separate the functions into a domain (control plane) of the control signaling function and a domain (user plane) of the data transmission and reception function.

In 5G, nodes of the control plane (CP) may be defined as follows: an access and mobility management function (AMF) that controls radio access by a terminal; a policy control function (PCF) that manages and controls policies such as terminal information, subscription service information for each terminal, and charging; a session management function (SMF) that controls and manages sessions for data service use by each terminal; a network exposure function (NEF) that is responsible for a function of sharing information with external networks; a unified data management/authentication function (UDM/AUSF) that manages and controls subscriber DBs and authentication of a user; a network repository function (NRF) that performs a function of managing and controlling information on each network function (NF) within the network; a charging function (CHF) that processes charging of a subscriber; and a network data analytics function (NWDAF) that performs a function of collecting and analyzing various network data.

In 5G, a node of the user plane (UP) is defined as a user plane function (UPF) that, based on control (interworking) of the session management function (SMF), transmits and receives data between a terminal and a server on an external service network (e.g., the Internet) through a session with the terminal.

A control node of the control plane and a data node of the user plane in 5G may be collectively referred to as network functions (NFs).

In other words, 5G defines network functions (NFs) that perform specific functions in the control plane and the user plane, and the NFs are defined to interwork with each other by using a service-based interface (SBI).

Meanwhile, recently, research has been conducted on configuring a terminal (UE) as an NF by evolving the UE into a 5G architecture and implementing same as an NF, so that not only NFs of the control plane and the user plane but also the UE (hereinafter, referred to as a UENF) perform communication by consistently using a SBI.

The present disclosure relates to a technology enabling identification of and coping with the normality/abnormality of a network function (e.g., UENF, RANF, AMF, SMF, UPF, . . . ) described above and a normal/abnormal operation between NFs.

In current B5G/6G networks, a large number of network functions (NFs) exist, and a large amount of signaling occurs due to communications processed via a protocol based on an NF or an SBI between NFs.

In addition, as central offices evolve into structures such as redundancy or distributed deployment currently and in the future, a much larger amount of signaling compared to the number of equipment types occurs during NF-to-NF communication in actual common B5G/6G network environments.

Meanwhile, in B5G/6G network environments, a large number of signaling storms may occur in access and core networks due to abnormal operations of an NF, erroneous NF operations, and internal/external factors of the NF.

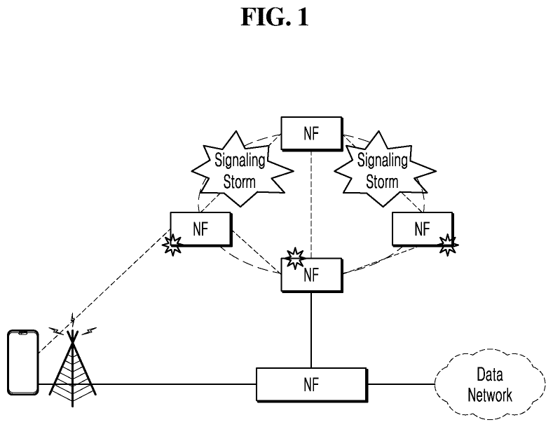

FIG. 1 illustrates an example of a problematic situation in which signaling storms occur between NFs in the control plane.

In communication technologies including 5G, normal call processing is one of the most important parts to operators in terms of stability, risk management (RM), and customer quality improvement/maintenance.

However, in the current B5G/6G standards, there is no method for detecting and coping with abnormal operations of an NF or between NFs or signaling storms.

In the current standards, it is assumed that an NF always operates “normally.” However, as the number of NFs increases, abnormal operations of an NF and between NFs, and signaling storms may occur due to errors, delays, BURST signaling, and the like.

That is, at present, it is impossible to determine an operation of an NF itself or whether an operation during communication between NFs is normal/abnormal, which may eventually lead to degradation in communication and quality experienced by customers. Alternatively, to prevent this, numerous resources are consumed, including a large investment cost by operators, redundancy/triple-redundancy of NF systems, and pre-/post-verification procedures (work start-up).

In fact, many current failures of NFs are mainly caused by faults, errors, or unexpected operations thereof, leading to growing concerns about the stability of the control plane (signaling) itself or the NFs themselves.

Therefore, the present disclosure proposes a new technical method enabling identification of and coping with the normality/abnormality of an NF and a normal/abnormal operation between NFs, so as to solve various problematic situations caused by the absence of measures in the current standards.

The core of the new technical method proposed in the present disclosure is to define a new analytics ID for the present disclosure between an NF and an NWDAF, to apply, to the NWDAF as an input (ingress), information required for analysis of communication between NFs, and to allow the NWDWF to output (perform egress of) an analysis/prediction result obtained by internal analysis processing (e.g., AI/ML processing) and transfer same to the NF.

Here, the NWDAF may be configured by a business support system/operational support system (BSS/OSS and O&M) in charge of business/operation and management, a data collection coordination function (DCCF) in charge of a storage and a connection message, an analytics data repository function (ADRF), a messaging framework adaptor function (MFEAF), a management data analytics service (MDAS), and an analytics logical function (AnLF) and a model training logical function (MTLF) in charge of AI/ML.

In the present disclosure, it may be assumed that the NWDAF is capable of comprehensively performing the above functions.

Here, the NWDAF proposed in the present disclosure may have federated learning (federated/distributed learning model) and centralized models, respectively or both.

The present disclosure may be applied to a unit of a function in a ULE (UENF), a base station (RANF), and a core (CNF), that is, all NFs (e.g., UENF, RANF, AMF, SMF, UPF, . . . ) in all the mobile communication fields.

However, in the following description, for convenience of explanation, a core NF is mentioned to describe specific embodiments.

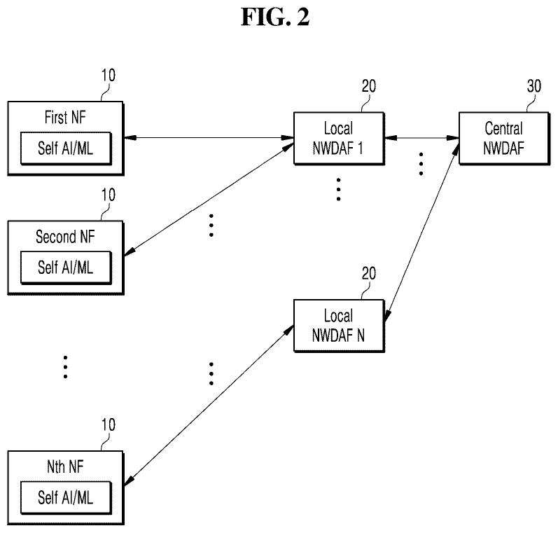

First, referring to FIG. 2, the core features of the present disclosure will be briefly described as follows.

As illustrated in FIG. 2, the technical method proposed in the present disclosure is applicable applied to all NFs 10 (e.g., UENF, RANF, AMF, SMF, UPF, . . . ), and is applicable to communication between the NFs 10 (e.g., UENF, RANF, AMF, SMF, UPF, . . . ) and NWDAFs.

FIG. 2 illustrates a first NF, a second NF, . . . , and an Nth NF as the NFs 10 to which the technical method of the present disclosure is applied, and illustrates a local NWDAF 20 and a central NWDAF 30 as a NWDAF to which the technical method of the present disclosure is applied.

The difference between the local NWDAF 20 and the central NWDAF 30 is only in the fact that the local NWDAF is an element for collecting and processing real-time information quickly and is implemented in units of local areas, and the central NWDAF 30 is implemented as an element for collecting and processing a large amount of non-real-time information.

That is, the present disclosure may be equally applied to the local NWDAF 20 and the central NWDAF 30, but the names may differ depending on the location and local role thereof.

That is, according to the present disclosure, a new analytics ID for the present disclosure may be defined between an NF and an NWDAF.

For example, as shown in Table 1 below, a new analytics ID, such as Signaling Storm, Erroneous NF, or Misbehaving NF, for identifying the normality/abnormality of an NF and a normal/abnormal operation between NFs may be defined.

TABLE 1

| | | | Event | | |
|---|---|---|---|---|---|
| Analytics ID | Analytics ID | Format | Condition | . . . | . . . |
| Signaling | Core network Signaling | . . . | Report every | . . . | . . . |
| Storm | Storm period, sudden | | 10 second | | |
| | burst signaling/ | | | | |
| | transactions from | | | | |
| | one or more NFs | | | | |
| Erroneous | NF that is not behaving | . . . | Report | . . . | . . . |
| NF | as expected | | immediate | | |
| Misbehaving | . . . | . . . | Notify when | . . . | . . . |
| NF | | | certain | | |
| | | | condition | | |
| | | | meet | | |

However, in the following description, the present disclosure will be described with a focus on the “Signaling Storm.”

Of course, in terms of the analytics ID name, Erroneous NF or Misbehaving NF may be generally used according to the purpose.

The present disclosure relates to a communication technique that defines a new analytics ID of “Signaling Storm” between the NF 10 and the NWDAF 20 or 30 and uses same.

According to the present disclosure, each NF 10 inputs (i.e., perform ingress of) and transfers, to the NWDAF 20 or 30 and based on an analytics ID of “Signaling Storm,” information (e.g., internal/external information, specific information specified by the NWDAF 20 or 30, etc.) required by the NWDAF 20 or 30 to predict an abnormal state (e.g., the presence or absence of a signal storm).

Therefore, in the present disclosure, the NWDAF 20 or 30 may analyze internal/external information or specific information from the NFs 10 through internal analysis processing (e.g., AI/ML processing) to predict an abnormal state (e.g., the presence or absence of a signal storm) of each NF 10 and between NFs 10 (e.g., the first NF, the second NF, . . . , and the Nth NF).

The NWDAF 20 or 30 may select and operate one of various algorithms, such as machine learning and deep learning algorithms, etc., as the internal analysis processing.

That is, the NWDAF 20 or 30 may specifically predict an abnormal state (e.g., the presence or absence of a signal storm) by selectively requesting/obtaining designated information from a desired NF (10) and re-analyzing same if necessary for detailed analysis/prediction.

In addition, in the present disclosure, the NWDAF 20 or 30 may transfer a result of analyzing/predicting an abnormal state (e.g., the presence or absence of a signal storm) of each NF 10 and between NFs 10 by outputting (performing egress of) same to an NF 10 required to receive the result, thereby enabling the NF 10 to perform a subsequent procedure according to the prediction result.

In particular, the present disclosure is to propose a specific communication technique between multiple NFs/NWDAFs using an analytics ID of “Signaling Storm.”

In the present disclosure, one NF 10 is able to interwork with multiple NWDAFs 20 and 30.

For example, as noted from FIG. 2, each NF 10 may predict/determine whether the NF is in an abnormal state, that is, in a signaling storm, through self-analysis (e.g., self AI/ML) by the NF.

In this case, each NF 10 may request a prediction result from the local NWDAF 20 located close to the NF in order to clarify prediction/determination of the NF's abnormal state, and if necessary, (additionally) request a prediction result from the central NWDAF 30.

In general, the local NWDAF 20 indicates an NWDAF which is responsible for prediction of an abnormal state (e.g., signaling storm) for NFs within a local area, and may be deployed at a location close to the NF 10 and perform quick collection and analysis (AI/ML) of real-time information with small capacity, low processing, or algorithm constraints so as to quickly predict an abnormal state (e.g., signaling storm).

The central NWDAF 30 indicates an NWDAF which is deployed for a range/area wider than that of the local NWDAF 20, and perform quick collection and analysis (AI/ML) of a large amount of non-real-time information with relatively large capacity, or high processing so as to accurately and specifically predict an abnormal state (e.g., signaling storm).

For example, when the NF 10 predicts/determines that the NF is in an abnormal state, that is, in a signaling storm, through self-analysis (e.g., self AI/ML) by the NF, and request the local NWDAF 20 to perform analysis for the NF and transmit a result of predicting an abnormal state (e.g., signaling storm), the local NWDAF 20 may analyze pieces of related information and perform an abnormal state (e.g., signaling storm) prediction procedure through internal analysis processing (e.g., AI/ML processing) to predict whether the NF 10 is in an abnormal state (e.g., signaling storm).

In this case, the local NWDAF 20 may immediately transfer, to the NF 10, a prediction result obtained by predicting whether the NF 10 is in an abnormal state (e.g., signaling storm), or transfer same to the NF 10 after additional analysis, according to the accuracy of the prediction result.

For example, the local NWDAF 20 may immediately transfer the prediction result to the NF 10 if the accuracy of the prediction result is high.

On the contrary, if the accuracy of the prediction result is lower than a pre-configured reference value, the local NWDAF 20 may transfer the prediction result to the NF 10 and, at the same time, transfer necessary information to the central NWDAF 30 and additionally request analysis for the NF 10 and a result of predicting an abnormal state (e.g., signaling storm).

In this case, the NF 10 may first perform a subsequent procedure according to the prediction result received from the local NWDAF 20, and then perform a subsequent procedure according to a prediction result that reflects “additional analysis and prediction by the central NWDAF 30” and is transferred from the local NWDAF 20 again.

Alternatively, if the accuracy of the prediction result is lower than a pre-configured reference value, the local NWDAF 20 may withhold the transfer of the prediction result to the NF 10, transfer necessary information to the central NWDAF 30, and additionally request analysis for the NF 10 and a result of predicting an abnormal state (e.g., signaling storm).

In this case, the local NWDAF 20 may transfer, to the NF 10, the prediction result of the local NWDAF and a prediction result reflecting “additional analysis and prediction by the central NWDAF 30,” and the NF 10 may perform a subsequent procedure according to the prediction results.

As described above, the present disclosure proposes a specific and adaptive communication technique between multiple NFs/NWDAFs, which indicates an NF and an NWDAF with which the NWDAF 20 or 30 is to communicate according to information analysis performed thereby and a prediction result.

In addition, in the present disclosure, the NF 10 may, if necessary, request analysis for the NF and a result of predicting an abnormal state (e.g., signaling storm) by transferring a request to both the local NWDAF 20 and the central NWDAF 30.

For example, the NF 10 may simultaneously request analysis for the NF and a result of predicting an abnormal state (e.g., signaling storm) from both the local NWDAF 20 and the central NWDAF 30, or may consider resources or a network state (e.g., load) to first request same from the local NWDAF 20 and, if necessary or possible, also from the central NWDAF 30.

In this case, if the NF 10 requests same only from the local NWDAF 20, the NF may perform a subsequent procedure according to a prediction request received from the local NWDAF 20, and if the NF requests same from both the local NWDAF 20 and the central NWDAF 30, the NF may perform a subsequent procedure according to a prediction request having a higher accuracy among the prediction results from both sides.

As described above, the present disclosure proposes a specific and adaptive communication technique between multiple NFs/NWDAFs, which enables the NF 10 to communicate with the multiple NWDAFs 20 and 30 to obtain a result of predicting an abnormal state (e.g., signaling storm) for a particular NF (e.g., the NF itself or another NF).

Eventually, the present disclosure implements a specific technical configuration (a communication technique between multiple NFs/NWDAFs for defining a new analytics ID between an NF and an NWDAF and using same) that enable identification of and adaptive coping with the normality/abnormality of an NF, a normal/abnormal operation between NFs, a signaling storm, and the like.

That is, a communication technique between multiple NFs/NWDAFs for defining a new analytics ID between an NF and an NWDAF and using same, which is implemented in the present disclosure, is an innovative technology that enables rapid and easy identification/detection of normal/abnormal operations in communication among a large number of NFs, and allows optimal coping/handling accordingly.

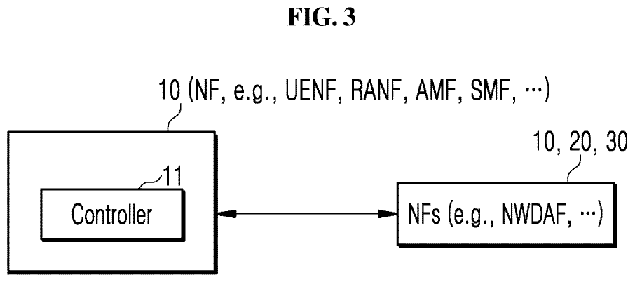

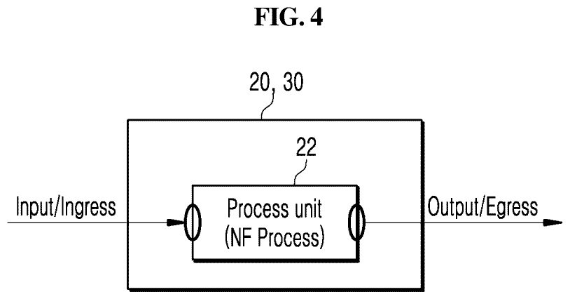

FIG. 3 and FIG. 4 illustrate configurations of an NF device according to an embodiment of the present disclosure.

Before providing a description with reference to FIGS. 3 and 4, an NWDAF used in the present disclosure will be described.

The NWDAF is 3GPP standard equipment, is equipment that receives source information (data) for analysis directly from an NF or via a data collection function (DCF) and performs the analysis, and may also include an operation of transferring a control request (e.g., recommendation) to the NF according to an analysis result (insight) (closed-loop feedback).

Such an NWDAF uses a service-based interface (SBI), and thus may use a basic request/response or subscription/notification scheme of the SBI at the time of data collection and transmission or reception of a control request, which are performed with an NF.

In the current standards, standardization for the NWDAF is being conducted, and the following is an example of an analytics ID currently defined.
UE Communication
UE Mobility
Expected UE behavior
Abnormal ULE behavior
Observed service experience
QoS Sustainability
User Data Congestion
Network Performance

As described above, in the current standards, the communication technique between an NF and an NWDAF has not been concretely defined, and in particular, there is no communication technique for identifying/detecting the normality/abnormality of an NF, a normal/abnormal operation between NFs, and a signaling storm, and coping therewith/taking action thereto.

In contrast, the present disclosure implements a specific technical configuration (a communication technique for defining a new analytics ID between an NF and an NWDAF and using same) for identifying/detecting the normality/abnormality of an NF, a normal/abnormal operation between NFs, a signaling storm, and the like and coping therewith/taking action thereto.

To continue the description, FIG. 3 is a diagram in view of each NF 10 (e.g., UENF, RANF, AMF, SMF, UPF, . . . ), and FIG. 4 is a diagram in view of the NWDAF 20 or 30 that performs an abnormal state prediction procedure of the present disclosure.

First, referring to FIG. 3, the NF device 10 according to an embodiment of the present disclosure may include a memory (not illustrated) including an instruction, and a processor (hereinafter, a controller 11) configured to execute the instruction to transfer information to be used for analysis to an NWDAF configured to perform an abnormal state prediction procedure through information analysis to request a prediction result obtained by performing the abnormal state prediction procedure, wherein the processor selects a particular NWDAF from among multiple NWDAFs according to the information to be transferred and transfers the information.

The controller 11 may be configured to receive, from the NWDAF, a prediction result obtained by predicting an abnormal state related to a particular NF, and perform a subsequent procedure according to the prediction result.

In the present disclosure, each NF 10 or the NWDAF 20 or 30 is equipped with an SBI module for transmitting and receiving SBI messages, and the SBI module basically performs input (receive or ingress)/processing (NF process)/output (send or egress).

Here, an interface of the SBI module may refer to a message (SBI message) defined in the SBI, and the protocol thereof may refer to a data packet including a header of an application layer, such as UDP/IP, TCP/IP, HTTP, HTTP/2, HTTP/3, and QUIC.

The controller 11 in the NF 10 according to the present disclosure may be configured to receive a prediction result obtained by predicting an abnormal state related to a particular NF, and perform a subsequent procedure according to the prediction result.

Here, the abnormal state may include a signaling storm caused by signals (signaling/transactions) generated in one or more NFs, or malfunction (erroneous/misbehaving) of the particular NF or between NFs.

The particular NF may refer to an NF for which the NF 10 has requested the prediction result, or an NF within a range for which the NF 10 has requested the prediction result.

That is, according to the present disclosure, each NF 10 (the controller 11) may determine an NF (the NF 10 itself or another NF) or an NF range for which the NF 10 wants to know the presence or absence of an abnormal state, and request the NWDAF 20 or 20 to transfer a prediction result, and the request may be made based on an analytics ID of “Signaling Storm.”

Accordingly, the controller 11 in the NF 10 may receive, from the NWDAF 20 or 30, a prediction result obtained by predicting an abnormal state (e.g., signaling storm) related to a particular NF, for which the prediction result has been requested, or an NF within a previously requested range, and receive the prediction result, based on an analytics ID of “Signaling Storm.”

Then, the controller 11 in the NF 10 may perform a subsequent procedure according to the received prediction result.

As described above, the present disclosure implements a communication technique between an NF and an NWDAF, based on an analytics ID newly defined between the NF and the NWDAF, for example, an analytics ID of “Signaling Storm.”

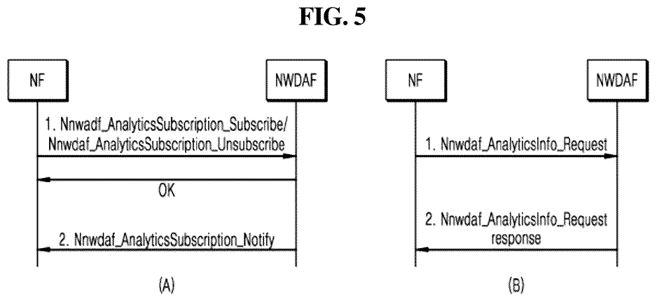

Referring to FIG. 5, for example, when the NWDAF 20 or 30 requests specific information from the NF 10, the NF 10 is a producer NF, and the NWDAF 20 or 30 is a consumer NF.

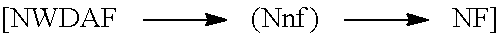

When the NF 10 wants to know a prediction result for an abnormal state of a particular NF and requests the prediction result from the NWDAF 20 or 30, the NWDAF 20 or 30 is a producer NF, and the NF 10 is a consumer NF.

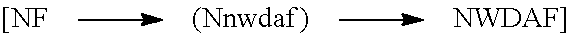

Here, a request scheme between an NF and an NWDAF may be a request/response scheme or a subscription/notification scheme, according to the SBI.

FIG. 5 illustrates a request operation in which the NWDAF 20 or 30 is a producer NF and the NF 10 is a consumer NF.

For example, FIG. 5(A) illustrates an operation in which, through the subscription/notification scheme, the NF 10 determines an NF (the NF 10 itself or another NF) or an NF range for which the NF 10 wants to know the presence or absence of an abnormal state, requests the NWDAF 20 or 30 to transfer a prediction result (Nnwdaf AnalyticsSubscription_Subscribe), and then receives the prediction result from the NWDAF 20 or 30 (Nnwdaf AnalyticsSubscription Notify).

Meanwhile, as illustrated in FIG. 5(B), through the request/response scheme, the NF 10 may determine an NF (the NF 10 itself or another NF) or an NF range for which the NF 10 wants to know the presence or absence of an abnormal state, request the NWDAF 20 or 30 to transfer a prediction result (Nnwdaf_AnalyticsInfo_Request), and immediately receive the prediction result from the NWDAF 20 or 30 (Nnwdaf_AnalyticsInfo_Request response).

The prediction result (insight) transferred from the NWDAF 20 or 30, which is an NF performing an abnormal state prediction procedure through information analysis, may be transferred based on a particular analytics ID newly defined for the abnormal state prediction procedure (see Table 1).

That is, the prediction result transferred from the NWDAF 20 or 30 may be transferred based on an analytics ID that is newly defined, for the present disclosure, between an NF and an NWDAF, such as Signaling Storm, Erroneous NF, and Misbehaving NF as shown in Table 1 described above.

However, the following description of an embodiment will be made by focusing on “Signaling Storm” as an abnormal state as described above.

Specifically, the controller 11 in the NF 10 according to the present disclosure may, as described above, determine an NF (the NF 10 itself or another NF) or an NF range for which the controller wants to know the presence or absence of an abnormal state (e.g., signaling storm), request (i.e., subscribe to) a prediction result therefor from an NWDAF.

In the following description, for the sake of descriptive convenience, an embodiment in which whether the NF 10 itself is in an abnormal state (e.g., signaling storm) is analyzed and requested will be described.

As described above, when the controller 11 of the NF 10 requests analysis and a prediction result according to performing of an abnormal state prediction procedure for the NF 10 itself, the controller may select a particular NWDAF from among multiple NWDAFs according to information to be used for a current analysis in an NWDAF, and transfer a request to the particular NWDAF.

Specifically, the processor, that is, the controller 11 may be configured to select a particular NWDAF from among multiple NWDAFs by using, as a criterion, at least one of whether the information to be used (transferred) for a current analysis in an NWDAF is real-time data or non-real-time data, an estimated processing time consumed for analyzing the information, and a capacity required for analyzing the information.

For example, the controller 11 of the NF 10 may, if the information to be used (transferred) for a current analysis corresponds to a type of real-time data, select, as a particular NWDAF, the local NWDAF 20 located close to the NF 10 from among multiple NWDAFs, and transmit a request to the local NWDAF 20.

Alternatively, the controller 11 of the NF 10 may, if an estimated processing time consumed for analyzing the information to be used (transferred) for a current analysis is longer than a reference time or if a capacity required for analyzing the information is larger than a reference capacity, select, as a particular NWDAF, the central NWDAF 30 from among multiple NWDAFs, and transmit a request to the central NWDAF 30.

In addition, the controller 11 of the NF 10 may be configured to consider resources or a network state (e.g., load) to first select the local NWDAF 20, as a particular NWDAF, and transmit a request to the local NWDAF 20 and thereafter, if necessary or possible, also select another NWDAF (e.g., another local NWDAF 20 or the central NWDAF 30), as a particular NWDAF, and transmit a request to the central NWDAF 30.

In a specific example, when the controller 11 of the NF 10 receives, from a particular NWDAF, for example, the local NWDAF 20, a prediction result of an abnormal state prediction procedure performed by analyzing the (transferred) information according to a current prediction result request, the controller may additionally select, as a particular NWDAF, another NWDAF (e.g., another local NWDAF 20 or the central NWDAF 30) from among multiple NWDAFs according to the prediction result, and additionally request a prediction result from the other NWDAF.

For example, when the controller 11 of the NF 10 receives, from the local NWDAF 20, a prediction result obtained by analyzing and predicting whether the NF 10 itself is in an abnormal state (e.g., signaling storm), the controller may perform a subsequent procedure according to the prediction result.

In this case, there may be a situation where it is impossible for the NF 10 to perform the subsequent procedure according to the current prediction result.

If it is determined that it is impossible to perform the subsequent procedure according to the current prediction result, the controller 11 of the NF 10 may determine that a re-request for a prediction result for performing an alternative subsequent procedure is required.

Therefore, the controller 11 of the NF 10 may be configured to, if it is determined that it is impossible to perform the subsequent procedure according to the current prediction result, additionally select, as a particular NWDAF, another NWDAF (e.g., another local NWDAF 20 or the central NWDAF 30) from among multiple NWDAFs, re-request a prediction result for performing an alternative subsequent procedure from the other NWDAF (also transfer information required for analysis if necessary), and perform a subsequent procedure according to the prediction result received from the other NWDAF (e.g., the other local NWDAF 20 or the central NWDAF 30).

It is obvious that, if it is determined that it is impossible to perform the subsequent procedure according to the current prediction result, the controller 11 of the NF 10 may notify the local NWDAF 20 of a situation where it is impossible to perform the subsequent procedure, re-request a prediction result for performing an alternative subsequent procedure from the other NWDAF (also transfer information required for reanalysis if necessary), and perform a subsequent procedure according to the re-received prediction result.

As described above, the present disclosure proposes a specific and adaptive communication technique between multiple NFs/NWDAFs, which enables the NF 10 to communicate with the multiple NWDAFs 20 and 30 to obtain a result of predicting an abnormal state (e.g., signaling storm) for the NF itself.

In the present disclosure, each NF 10 (e.g., UENF, RANF, AMF, SMF, UPF, . . . ) may be implemented in a VNF/VM form or a CNF/Pod form, and regardless of the form, may measure/extract internal information and external information of the NF and transfer same to the NWDAF 20.

Here, the internal information of the NF 10 refers to information on an internal processing state in the NF 10.

For example, the “internal information of the NE” may include all information that may be obtained in the NF 10, such as information on ongoing call processing, state information of a subscriber (group) and a usage rate of system resources (CPU/memory/disk), delay information on file I/O, a load level or a capacity relative to a designed limit, a resource information pool for call processing, or a routing table.

In addition, the internal information of the NF 10 may measure/include an OAM domain and a control plane processing logic managed by the NF 10.

The internal information of the NF as described above may be tabulated and represented as in Table 2 below. That is, the internal information of the NF 10 includes information as shown in Table 2, and may be measured/updated/transferred (NF-NWDA) under various conditions such as a periodic condition or a condition that a specific threshold has been reached.

TABLE 2

| | | | | | | | | |
|---|---|---|---|---|---|---|---|---|
| | | Complete(Sucess/ | | | | | Backoff-time | |
| | | Attempt) Ratio | | | | | to be normal | |
| Context | | per Each Call | Resource | Processing | Capa. and | | status | |
| Amount | Context Status | Procedure | Usage | Latency | Load | Locality | (minimum) | . . . |

| | | | | | | | | |
|---|---|---|---|---|---|---|---|---|
| Ex. 1 | 2M (UE) | MM Registered: | Registration-Pod | Registration- | Registration: | Capacity: | Logical | 10 mins to |
| | | 1,825,670 | reroute: 17.65% | Pod CPU: 30% | 3 ms | 100/255 | Locality: | reducing the |
| | | MM De- | Paging Area | CPU-peak: 67% | Handover: 2 ms | Load: | Sung-Soo | Load (from |
| | | Registered: | Prediction | Mem: 13% | Authentication: | Criti- | Geo: 43 46 9 | 80% to 60%) |
| | | 174,330 | Accuracy(1^{st}): | MEM-peak: | 4 ms | cal(80%) | 11 15 22.2 | |
| | | | 98.67% | 23% | UP Activation: | | | |
| | | | | Disk: 5% | 5 ms | | | |
| Ex. 2 | 10,245 | Updated In | UDR write | CPU: 5 m | Subs' Info | Capacity: | Set_1 | 120 secs to |
| | (Subscriber's | 5 min: 6241 | collision: 34.13% | CPU-peak: | Update: 15 ms | 70/100 | | reducing the |
| | Data) | 10 min: 1921 | DBCC-Pod | 14 m | Subs' Info | Load: | | Load (from |
| | | 20 min: 574 | reroute: 3.57% | Mem: 34 mi | Delete: 4 ms | Minor(85%) | | 85% to 75%) |
| | | 30 min: 36 | | MEM-peak: | Subs' Info | | | |
| | | A hour: 8 | | 41 mi | Push/Pop: 20 ms | | | |
| | | Out of date: 1465 | | Disk: 55% | | | | |
| Ex. 3 | 10,240,000,000 | CM Connected: | SessionHandling- | CPU: 67 m | Session | Capacity: | TAC: | 40 secs to |
| | (Session) | 29,110,324 | Pod reroute: | CPU-peak: | Establishment: | 32,000,000/ | H′AE23C1 | reducing the |
| | | RRC active: | 32.55% | 95 m | 43 ms | 40,000,000 | | Load (from |
| | | 11,132,201 | Session | Mem: 67 mi | Session Owner | Load: | | 85% to 55%) |
| | | RRC idle: | Establishment | MEM-peak: | Switching: | Major(85%) | | |
| | | 17,978,123 | handling: 99.97% | 99 mi | 21 ms | | | |
| | | CM Idle: | | Disk: 5% | Session | | | |
| | | 10,889,676 | | | Retrieve: 8 ms | | | |

When defining such internal information of the NF as an embodiment, the internal information may be composed of a combination of the following pieces of information.
Context Amount: The amount of unit (subscribers, sessions, profiles, etc.) information currently accommodated in the system
Context Status: Main state information of per-unit information currently accommodated in the system
Complete (Success/Attempt) Ratio per Each Call Procedure: A main success rate during internal processing of the system in a main call processing procedure related to the system (e.g., an overhead element such as re-transmission between pods in the system)
Resource Usage: A current load rate (or usage rate) of main system resources (CPU, memory, or disk)
Processing Latency: A time consumed for internal processing of the system in a main call processing procedure associated with the system
Capacity/Load: Capacity (not a simple ratio, but a value indicating the scale) and load information of the overall system
Locality: This is location information of the system, and may be logical location information, physical location information, or an operator-designated unit
Backoff-time to be normal status (minimum): An (estimated) time required to be secured for load alleviation (or a system state change to a normal range for a main factor)
At least one of pieces of statistical information on configuration management (CM)/performance management (PM)/fault management (FM) is included

Meanwhile, the external information of the NF 10 may refer to information on communication performed by the NF 10 through a network connection, that is, communication with another NF/UE/base station/ISP.

For example, the external information of the NF may refer to information obtainable by the first NF in communication with the second NF, under the assumption of a communication situation in which the first NF and the second NF interwork with each other.

In addition, for example, the “external information of the NE” may include all information that may be obtained in an interworking/communication process, such as the amount/response time/success or failure (success rate) of a transmission or reception message and a health check result, state information (load, capacity, status, cause, etc.) received from the second NF, the number of TCP connections created for interworking, sequence ID #, and the amount (an absolute value or ratio) of context processed through interworking with the second NF among the amount of context processed by the first NF.

As such, the external information (internal information) of the NF in the present disclosure may include state information on some or all of the speed, load, and consistency measured for each signaling type with regard to an interface (hereinafter, referred to as a communication interface) for the input (ingress) and output (egress) of the NF.

More specifically, the signaling type of the communication interface configuring the external information (internal information) of the NF may be defined as follow.
Physical type (e.g., wired→USB type, optical cable, copper cable, etc., wireless→Wi-Fi), and physical module (e.g., optical transceiver and RJ45 transceiver)
Physical port position (e.g., port 1 or port 2)
Physical/logical combination information (e.g., a combination of 4 10GbE LAN cables, and an active-standby/active-active redundancy structure)
Logical identification information (e.g., Usb1, Eth1, wlan1, br1, etc.)

The speed of the communication interface configuring the external information (internal information) of the NF may be defined as follow.
Bandwidth (e.g., bandwidth 1 Gb/s, 10 Gb/s, etc.)
Transmission rate (ex: throughput 10 Mb/s, 1 Gb/s, etc.)
Uplink/Downlink distinction
Total number of sessions being processed
Classification of each detailed message within each session being processed (e.g., classification by service name, operation, and attribute)
The load of the communication interface configuring the external information (internal information) of the NF may be defined as follow.
State information on resource load for ingress or egress related to interface processing (e.g., CPU/memory/storage usage)
State information on interface load connected to ingress or egress related to interface processing (e.g., transaction per second (TPS) or connection per second (CPS)))

Burst information (e.g., signaling TPS or CPS such as Min/Avg/Max)
Unidirectional and bidirectional delay value (e.g., RTT)

The consistency of the communication interface configuring the external information (internal information) of the NF may be defined as follow.
Alarm, error, fault cause and reason for each signaling message type
Signaling message verification or validation information
Overload information
Re-transmission count information
Processing delay information between Req and Ack

For example, extraction/measurement of the speed of the communication interface configuring the external information (internal information) of the NF 10 is described as follow.

The NF 10 may classify various signaling types (e.g., SBI, Non-SBI, or OAM) of a control/management plane transmitted or received via a communication interface for input (ingress) and output (egress), and extract a speed rate of input (ingress) to the NF 10 for each signaling type.

The speed rate may follow a particular Poisson distribution in view of the NF 10, and corresponding queuing may be extracted together.

That is, a rate indicating a sudden burst occurring within a specific time or period, or a rate requiring a large processing time within a particular period from the perspective of the NF 10 may be extracted.

For example, the NF 10 may assume to receive 128 specific SBI HeartBeat messages per second from another NF, and it may take a predetermined time to normally process the HeartBeat, and then the NF may process the content and transmit a reply to the other NF.

All of these values may be measured/extracted as “external information of the NF,” and transferred to the NWDAF 20 and/or 30.

As described above, the NF 10 (the controller 11) in the present disclosure may measure/extract the above-described internal/external information of the NF periodically or as needed, and may transfer same to the NWDAF 20 and/or 30 periodically or as needed.

In this case, the NF 10 (the controller 11) in the present disclosure may input (i.e., perform ingress of) and transfer the measured/extracted internal/external information of the NF to the NWDAF 20 and/or 30, based on an analytics ID of “Signaling Storm.”

For reference, the transfer may be performed in the order of the NF 10→NRF→NWDAF (the NWDAF 20 or 30 or the local NWDAF 20→the central NWDAF 30), but for the sake of simplicity in explaining the present disclosure, it should be understood as being transferred in the order of the NF 10→NWDAF (the NWDAF 20 or 30 or the local NWDAF 20→the central NWDAF 30).

The importance of such internal/external information of the NF lies in the fact that the actual cause, analysis, and prediction of a signaling storm may require both the internal and external information of the NF.

In addition, various information values included in the internal/external information of the NF are related to only pieces of information that may be very helpful in detecting a signaling storm.

In particular, the external information of the first NF may be related to information which is transmitted/received to/from the first NF and related to another NF (the second NF, . . . , and the Nth NF).

For example, the TPS/CPS of SBI messages received from another NF (the second NF, . . . , and the Nth NF), and consequential information indicating how severe bursts or delays occur in the other NF (the second NF, . . . , and the Nth NF) through the TPS/CPS may be transferred to an NWDAF (the NWDAF 20 or 30 or the local NWDAF 20→the central NWDAF 30).

In addition, the NF 10 (the controller 11) in the present disclosure may input (i.e., perform ingress of) and transfer only specific information of the NF 10 specified by the NWDAF 20 or 30, other than the described internal/external information of the NF, to the NWDAF 20 or 30, based on an analytics ID of “Signaling Storm.”

For example, autonomously according to a local policy of the NF 10, or based on interaction with, or a request (or subscription) from, the NWDAF 20 or 30, the NF 10 may filter only specific information, and input (i.e., perform ingress of) and transfer the same to the NWDAF 20 or 30, based on an analytics ID of “Signaling Storm.”

If filtering is performed by the NF 10 as described above, there is no need to transfer all the information to the NWDAF 20 or 30, so that the NF 10 may obtain only specific information through filtering, and transfer same according to a network state or a state of the NF 10 in an autonomous manner.

In a case of interaction with/a request (or subscription) from the NWDAF 20 or 30, when information (specific information) on the NF 10 is additionally required by the NWDAF 20 or 30, the NWDAF may request (or subscribe to) the specific information in a direction of NWDAF→NF.

Referring to FIG. 4, the NFDAF 20 or 30 according to an embodiment of the present disclosure may include a memory (not illustrated) including an instruction, and a processor (hereinafter, a process unit 22) configured to execute the instruction to receive information for an abnormal state prediction procedure from each NF, perform the abnormal state prediction procedure by analyzing the information, and transfer a prediction result of an abnormal state related to a particular NF to a consumer NF so as to enable the consumer NF to perform a subsequent process according to the prediction result.

Then, the process unit 22 may be configured to transfer information to another NWDAF or request additional information from another NWDAF according to the prediction result of the abnormal state related to the particular NF.

The abnormal state prediction procedure related to the particular NF performed by the process unit 22 of the NFDAF 20 or 30 may be performed by analyzing internal information and external information of the particular NF.

Specifically, the process unit 22 may perform an abnormal state prediction procedure of analyzing internal/external information or specific information from each NF 10 through analysis processing (e.g., AI/ML processing), thereby analyzing/predicting an abnormal state (e.g., the presence or absence of a signal storm) of each NF 10 and between NFs 10.

In addition, when a request for a result of predicting an abnormal state (e.g., signaling storm) for a particular NF (e.g., the NF 10 itself or another NF) is transferred/received from the NF 10 or another NWDAF 20 or 30, the process unit 22 may perform an abnormal state prediction procedure through information analysis according to the request, thereby analyzing/predicting an abnormal state (e.g., the presence or absence of a signal storm) of the particular NF (e.g., the NF 10 itself or the other NF).

In this case, the analysis processing (e.g., AI/ML processing) used by the process unit 22 may employ a centralized or decentralized AL/MIL algorithm. The algorithm may be classified into four types.
Supervised Learning, Unsupervised Learning, Semi-supervised Learning, and Reinforcement Learning

The detailed algorithm thereof may use Linear regression, Logistic regression, Decision tree, SVM algorithm, Naive Bayes, KNN, K-means, Random forest, Dimensionality reduction, Gradient boosting, or AdaBoosting, XGBoost. The algorithm may be dynamically changed according to various data types, characteristic/features and real-time/non-real-time nature, or periods.

Therefore, in the present disclosure, an input (ingress) applied from each NF 10 to the NWDAF 20 or 30 for information analysis is applied based on an analytics ID of “Signaling Storm,” and may include internal/external information of each NF 10, specific information of the NF 10 specified by the NWDAF 20 or 30, a Request or Subscription message through which the NF 10 requests a prediction result for a particular NF (the NF 10 itself, another NF, or an NF within an NF range), or a Request or Subscription message through which information transfer and a prediction result are requested by another NWDAF 20 or 30.

Then, in the present disclosure, an output (egress) generated by the NWDAF 20 or 30 is output based on an analytics ID of “Signaling Storm.”

As described above, the output (egress) generated by the NWDAF 20 or 30 may include a Request or Subscription message that requests transfer of internal/external information of each NF 10, a Request or Subscription message that requests transfer of specific information of the NF 10, a Response or Notification message that transfers a prediction result (insight) obtained by predicting an abnormal state, or a Response or Notification message that transfers information or a prediction result requested by another NWDAF 20 or 30.

Accordingly, the process unit 22 of the NWDAF 20 or 30 may perform an abnormal state prediction procedure of analyzing internal/external information of each NF 10 or specific information of the NF 10, or information transferred together with a request, which is applied based on an analytics ID of “Signaling Storm,” thereby analyzing/predicting an abnormal state (e.g., the presence or absence of a signal storm) of each NF 10 and between NFs 10.

Then, the process unit 22 of the NWDAF 20 or 30 may output/transfer, based on an analytics ID of “Signaling Storm,” a prediction result (insight) for a particular NF suspected to be in an abnormal state (e.g., signaling storm) to the NF 10 which has previously requested transfer of the prediction result (insight) for the particular NF.

The process unit 22 may request each NF 10 to transfer internal/external information, based on an analytics ID of “Signaling Storm,” and receive the internal/external information from each NF 10, based on an analytics ID of “Signaling Storm.”

Furthermore, the process unit 22 may, according to a condition (e.g., accuracy) in which an abnormal state (e.g., signaling storm) of a particular NF is suspected during an abnormal state prediction procedure, request additional specific information (more detailed statistical data (5 minutes>1 minute), specific data (cause-specific statistics, log), and more frequent cycle updates) from the particular NF (or associated another NF), based on an analytics ID of “Signaling Storm.”

Accordingly, the process unit 22 may receive the additional specific information input/acquired based on the analytics ID, and perform a re-analysis/abnormal state prediction procedure, thereby predicting, in detail, the abnormal state (e.g., the presence or absence of a signaling storm) of the particular NF.

Alternatively, the process unit 22 may transfer information to another NWDAF 20 or 30 or request additional information from another NWDAF 20 or 30 according to a prediction result derived by performing an abnormal state prediction procedure for a particular NF.

Specifically, the process unit 22 may be configured to control information transfer to another NWDAF 20 or 30 by using, as a criterion, at least one of accuracy, impact, and urgency for a prediction result derived by performing an abnormal state prediction procedure for a particular NF.

For example, the process unit 22 may be configured to, when it is determined that the accuracy of the prediction result is lower than a pre-configured reference value or the impact thereof is a high level, transfer necessary information to selected another NWDAF (another local NWDAF 20 or the central NWDAF 30), thereby enabling the information to be used during an abnormal state prediction procedure for deriving a final prediction result for the particular NF, the procedure being performed by the other NWDAF (the other local NWDAF 20 or the central NWDAF 30).

In this case, the final prediction result according to the abnormal state prediction procedure performed for the particular NF in the other NWDAF (the other local NWDAF 20 or the central NWDAF 30) is transferred to the NF 10, whereby the NF 10 may receive the final prediction result derived by the other NWDAF (the other local NWDAF 20 or the central NWDAF 30) cooperating/interworking with the NWDAF 20 or 30 directly requested by the NF, and perform a subsequent procedure according thereto.

As another example, the process unit 22 may be configured to, when it is determined that the accuracy of the prediction result is lower than a pre-configured reference value or the impact thereof is a high level, request and receive necessary additional information from selected another NWDAF (another local NWDAF 20 or the central NWDAF 30) and then re-perform an abnormal state prediction process of analyzing even the additional information for the particular NF to derive a final prediction result and transfer same to the NF 10.

In this case, the NF 10 may receive the final prediction result derived by cooperation/interworking between the other NWDAF (the other local NWDAF 20 or the central NWDAF 30) and the NWDAF 20 or 30 directly requested by the NF, and perform a subsequent procedure according thereto.

Furthermore, the NWDAF 20 or 30 (the process unit 22) may perform an abnormal state prediction procedure by classifying an analysis/prediction range (signaling storm zone) in which the procedure is performed into a signaling storm range, a duration, and a service impact failure prediction range.

In this case, the analysis/prediction range may be distinguished by a zone ID, and for example, may be distinguished/defined by a slice, an NF cluster, or a specific UE and RAN location (ECGI, NCGI, or GPS).

Therefore, in the present disclosure, each NF 10 may request (or subscribe to) a prediction result from the NWDAF 20 or 30 by using a zone ID of an NF range for which the NF wants to know the presence or absence of an abnormal state.

The prediction result (analytics output) output by the NWDAF 20 or 30 in the present disclosure as described above may have information indicating the accuracy of the prediction result and a subsequent procedure for coping with a predicted abnormal state (e.g., signaling storm).

For example, the prediction result (analytics output) may be divided into the following three: Prediction, Required Action, and Recommended Action.

Prediction: This indicates the accuracy of occurrence of a signaling storm. In addition, specific values may be as follows.
Storm time, e.g., 2023-04-12, 17:45:48:700
Storm Period (duration), e.g., 00:05:03
Accuracy, e.g., 85% (For reference, this may be a final ROC curve graph value by considering precision and recall values).
Process information: This includes a description for an AI/NL type, an algorithm, and a parameter used to extract the prediction value, an equation, a formula, and the like. This information may be referenced by the NF 10, and if necessary, a parameter update may be additionally requested.
Signaling Storm Zone: This indicates filtering information on a particular NF cluster, such as the location of a particular NF in units of groups, an NW Slice, a UE/RAN location, etc. The reason for the existence of this information is that there may be a plurality of core networks, base stations, and UEs, and the NF may want to know the presence or absence of an abnormal state (e.g., a signaling storm) only for a particular NF range. In addition, the reason is that a signaling storm may occur in the entire core network, multiple core networks, or partially within a core network.

Prediction in the present disclosure is required to be always included in a prediction result (analytics output).

Therefore, each NF 10 that receives a prediction result (analytics output) from the NWDAF 20 or 30 may perform a subsequent procedure according to the prediction result (analytics output) by referencing Prediction and, at the same time, following the two kinds of actions described below which are included in the prediction result (analytics output).

Among the two actions, Required is mandatory, and Recommended may be selected by the NF at the end.
Required Action: This indicates a subsequent procedure as a necessary action for minimizing the impact of a signaling storm.

The NF 10 that receives a prediction result (analytics output) from the NWDAF 20 or 30 is necessarily required to perform a subsequent procedure according to a (mandatory) Required Action at the highest priority. For example, the Required Action may be defined by the following action plans.
Unselect NF #~NF #: This excludes a particular NF (in which a signaling storm occurs) from particular call processing (procedure) (thereby, avoiding the impact of the signaling storm).
pps reduction: This reduces the speed for a particular target NF (packet per second, transaction per second, or connection per second)
Overload protection: This performs overload control for a particular ULE, each area/location, and each base station ID. This may use various backoff timers to adjust the speed/interval of registration (attach) or session establishment/modification for a particular UE/session (data, ims, etc.).
Rejection: This may adjust speed by variously changing a message indication in a manner of transferring a particular cause (EMM, ESM, SIP, or SBI cause) to a particular NF/UE (for a particular procedure) as a failure response.
Configuration: This may transfer local, global configuration, and setup information to a particular NF/UE to add/change/remove a connection scheme, a capability of the NF/UE, a high/med/low processing mode, and internal/external information so as to change a parameter related to a procedure scheme.
Recommended Action: This indicates s subsequent procedure recommended as an action for the impact of a signaling storm.

The NF 10 that receives a prediction result (analytics output) from the NWDAF 20 or 30 may selectively perform a Recommended Action.

Recommended Action may include the same information as Required Action, but may be typically used when Prediction accuracy is low.

As described above, the present disclosure implements a specific technical configuration enabling identification of and optimal coping with the normality/abnormality of an NF, a normal/abnormal operation between NFs, a signaling storm, and the like by implementing a communication technique between an NF and an NWDAF for defining a new analytics ID for predicting an abnormal state (e.g., signaling storm) between an NF and an NWDAF and using same, in particular, a communication technique between multiple NFs/NWDAFs.

An NF range to which the present disclosure is applied is not limited to a core NF.

That is, an abnormal state (e.g., signaling storm) may occur in a non-access stratum (NAS) of a ULE (UENF), and may occur in a CU-CP, CU-UP, DU, and RU of a base station (RANF) as well (e.g., E1, F1-c, or F1-u).

If a ULE (UENF) is used as the NF device 10 to which the present disclosure is applied, the UENF 10 may be implemented as an NF including a communication unit (hereinafter, service-based interface (SBI) module) for performing communication by using an SBI message according to an SBI between NFs.

Therefore, all the above embodiments of the present disclosure may be applied to a UEFE (UE func) and an RANF (base station func) in the same way, and the application range of the present content is common to all NFs from the perspectives of a UE, a base station, and a core. That is, the NF device 10 to which the present disclosure is applied may be a UE, that is an UENF, which is implemented as an NF as described above.

However, the following description mainly refers to a network function (NF or core) that may be commonly applied.

In addition, since input/process/output information and a state for a signaling storm are transmitted/received in an operation between a UE (UENF) and a NAS (MM core), the UE (UENF) may also determine an operation trigger/condition for signaling storm processing.

If a ULE (UENF) is used as the NF device 10 to which the present disclosure is applied, a large number of UENFs 10 may cause signaling storms.

For example, the UENF 10 may receive, from the NWDAF 20 or 30, a prediction result (analytics output) obtained by analyzing/predicting an abnormal state (e.g., signaling storm) at the time of a handover of a UE, that is, the UENF 10, at the time of a specific coverage entry, or according to UE slice information, an emergency mode, or the battery state of the UE.

The UENF 10 having received the prediction result (analytics output) may “select” a base station/core network according to the presence or absence of a signaling storm, and, at the same time, may continuously inform a core NWDAF 20 or 30 of information (e.g., internal/external information, specific information specified by the NWDAF 20 or 30, and the like) of the UENF 10.

That is, the UENF 10 may select a core network in a ULE-triggered or network-triggered manner according to the signaling storm (i.e., congestion level).

As described above, the present disclosure implements a specific technical configuration enabling identification of and coping with the normality/abnormality of an NF (e.g., UENF, RANF, AMF, SMF, UPF, . . . ), a normal/abnormal operation between NFs, a signaling storm, and the like by implementing a communication technique between an NF and an NWDAF and between multiple NFs/NWDAFs for defining a new analytics ID for predicting an abnormal state (e.g., signaling storm) between an NF and an NWDAF, and analyzing/predicting an abnormal state such as a signaling storm) by using the ID.

Accordingly, in the present disclosure, an effect of enabling detection of the abnormality of an NF, abnormal operations between NFs, and signaling storms, and optimally coping therewith, and an effect of avoiding degradation in communication and quality experienced by customers, which may be caused thereby, are derived.

Hereinafter, a signaling control method (a communication technique between an NF and an NWDAF) performed in an NF according to an embodiment of the present disclosure will be described.

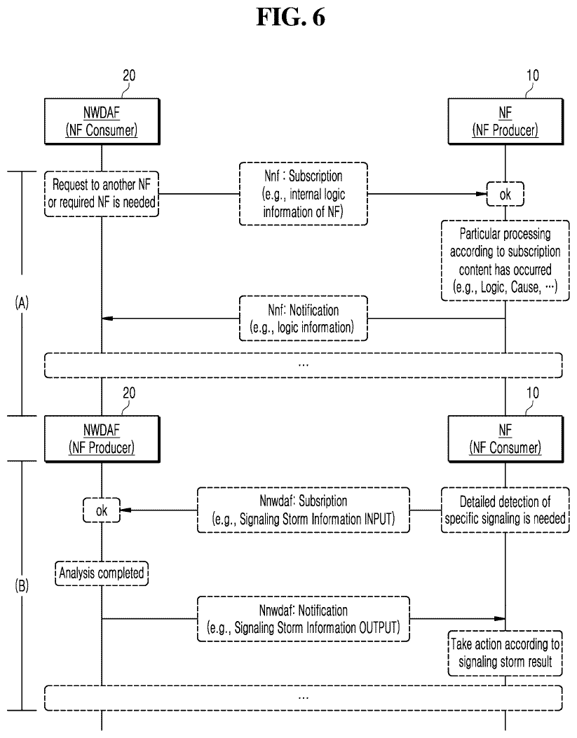

FIG. 6 to FIG. 10 are embodiments each showing a call flow proceeding according to a signaling control method performed in an NF, that is, a communication technique between an NF and an NWDAF according to the present disclosure.

Before the description, in FIGS. 6 to 10, although not illustrated for the sake of descriptive convenience, it should be understood that a new analytics ID for predicting an abnormal state (e.g., signaling storm) is used when messages are transmitted and received between an NF and an NWDAF.

In the following description for FIGS. 6 to 10, for the sake of descriptive and illustrative convenience, one NWDAF 20 is illustrated and described, and this NWDAF 20 may be a local NWDAF or a central NWDAF.

Referring to FIG. 6, FIG. 6 illustrates a procedure for searching for a signaling storm through communication between an NF and an NWDAF.

Process (A) in FIG. 6 is an embodiment in which the NWDAF 20 corresponds to a consumer NF, and an NF 10 that receives a current request corresponds to a producer NF.

For example, the NWDAF 20 may, according to a condition (e.g., accuracy) in which an abnormal state (e.g., signaling storm) of a particular NF is suspected during an abnormal state prediction procedure, request additional specific information from another NF or a required NF (Subscription, e.g., NF internal information request w/filtering).

As described above, many resources may be required for each NF 10 to measure/extract the entire internal information.

Therefore, the NWDAF 20 may primarily determine what information is currently insufficient in view thereof, and then request only necessary information from the NF 10. Thereafter, the NF 10 measures/extracts information required/specified by the NWDAF 20 and transfers same to the NWDAF 20.

Process (B) in FIG. 6 is an embodiment in which the NWDAF 20 corresponds to a producer NF, and an NF 10 that receives a current request corresponds to a consumer NF.

From the perspective of the NF 10, the NF 10 may want to know whether there is a signaling storm for a particular NF, for example, by determining the necessity of detailed detection of specific signaling. In this case, the NF 10 may request the NWDAF 20 to transfer a prediction result for the particular NF (Subscription, e.g., signaling storm information input).

Therefore, when the NWDAF 20 has completed the performance/analysis of an abnormal state prediction procedure for the particular NF requested by the NF 10, the NWDAF may return the prediction result (Notification, e.g., signaling storm information output) (Notification).

Then, the NF 10 may perform a subsequent procedure according to the prediction result (Notification, e.g., signaling storm information output).

In this case, the NF 10 may, if necessary, again transfer the completion level (feedback/reward score) of a result of a corresponding action to the NWDAF 20, and the NWDAF 20 may, based thereon, identify how well the action of the corresponding subsequent procedure has been performed and proceed in a closed-loop manner.

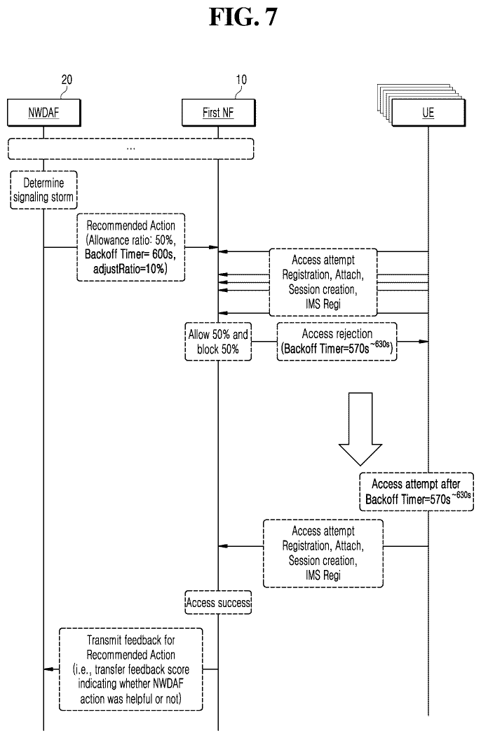

Next, referring to FIG. 7, in a case where the NWDAF 20 performs an abnormal state prediction procedure and predict/determine a signaling storm, the NWDAF may transfer a current prediction result therefor to the NF 10 (e.g., the first NF) which has requested the prediction result.

In this case, the prediction result (analytics output) necessarily includes Prediction, and at least one of a Required Action and a Recommended Action is further included.

FIG. 7 shows an embodiment of, as a Recommended Action, controlling an allowance ratio through AdjustRatio adjustment.

AdjustRatio is an adjustable range value of a backoff timer, and a random value obtained by increasing/decreasing the backoff timer value by a corresponding ratio is applied to prevent multiple overlapping requests/access attempts from occurring at the same time, thereby inducing requests/access attempts spread over a certain time duration after the timer expires.

Therefore, as shown in FIG. 7, the NF 10 (e.g., the first NF) that has received the current prediction result adjusts a backoff timer value to allow only 50% of the requests/access attempts from a ULE and to reject the remaining access attempts, so as to induce reduction of the requests/access attempts from the UE, and allows 100% of the requests/access attempts after the backoff timer. In this case, since a signaling storm may have already been resolved by the reduced requests/access attempts, most of the requests/access attempts after the backoff timer are expected to succeed.

Furthermore, the NF 10 (e.g., the first NF) may transfer the completion level (feedback/reward score) of a current Recommended Action to the NWDAF 20, as necessary.

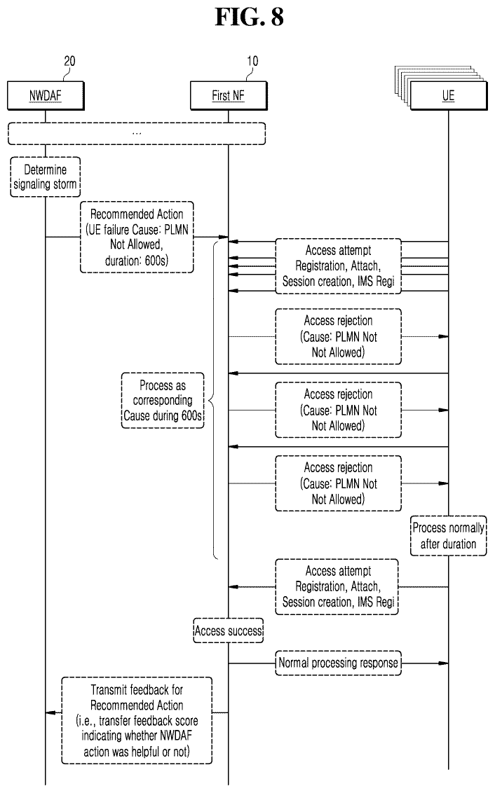

Next, referring to FIG. 8, in a case where the NWDAF 20 performs an abnormal state prediction procedure and predict/determine a signaling storm, the NWDAF may transfer a current prediction result therefor to the NF 10 (e.g., the first NF) which has requested the prediction result.

FIG. 8 shows an embodiment of, as a Recommended Action, returning a particular cause (cause: PLMN Not Allowed) as a failure response during a predetermined duration.

As illustrated in FIG. 8, the NF 10 (e.g., the first NF) that has received the current prediction result may return a failure response of a particular cause (cause: PLMN Not Allowed) for a request/access attempt from a UE during a predetermined duration, thereby inducing reduction of the requests/access attempts from the UE.

Then, the NF 10 (e.g., the first NF) normally accepts a request/access attempt from a ULE again after the predetermined duration, and most of the requests/access attempts are expected to succeed.

Furthermore, the NF 10 (e.g., the first NF) may transfer the completion level (feedback/reward score) of a current Recommended Action to the NWDAF 20, as necessary.

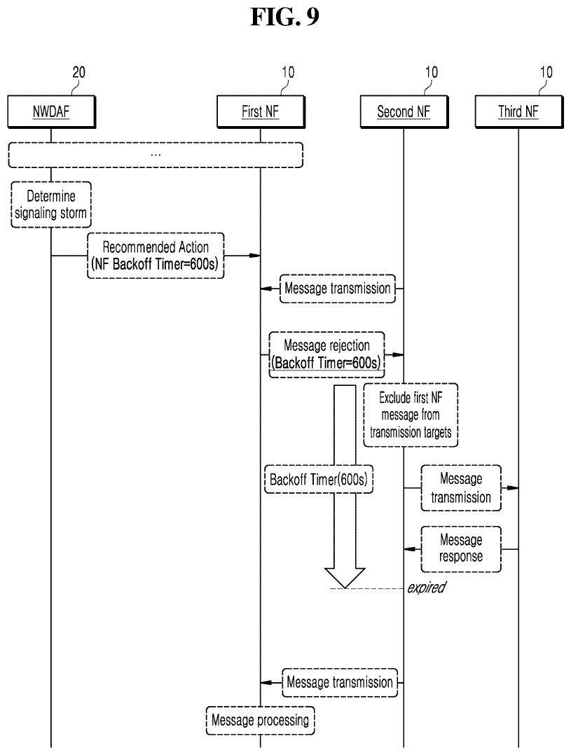

Next, referring to FIG. 9, in a case where the NWDAF 20 performs an abnormal state prediction procedure and predict/determine a signaling storm, the NWDAF may transfer a current prediction result therefor to the NF 10 (e.g., the first NF) which has requested the prediction result.

FIG. 9 shows an embodiment of, as a Recommended Action, rejecting a message from an NF according to an NF backoff timer equal to 600 s.

As illustrated in FIG. 9, the NF 10 (e.g., the first NF) that has received the current prediction result may not process and reject a message transmitted from a second NF according to the prediction result and notify the second NF of a backoff timer equal to 600 s.

Accordingly, the second NF may exclude the NF 10 (e.g., the first NF) from message transmission targets and communicate a third NF to substitute by transmitting/receiving a message. After the backoff timer equal to 600 s expires, the second NF may transmit a message to the NF 10 (e.g., the first NF) if necessary, and the NF 10 (e.g., the first NF) may normally process a message transmitted from the second NF after the NF backoff timer equal to 600 s expires.

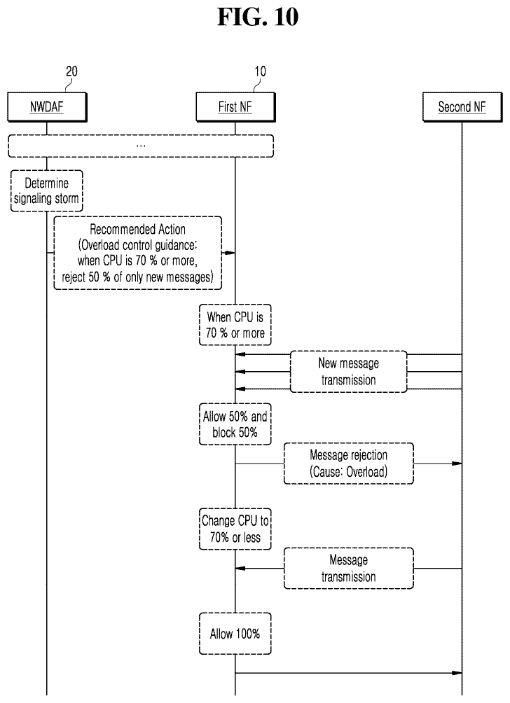

Next, referring to FIG. 10, in a case where the NWDAF 20 performs an abnormal state prediction procedure and predict/determine a signaling storm, the NWDAF may transfer a current prediction result therefor to the NF 10 (e.g., the first NF) which has requested the prediction result.

FIG. 9 shows an embodiment of, as a Recommended Action, transferring a guidance (e.g., when the CPU is 70% or more, 50% of only new messages are rejected) for controlling overload.

As illustrated in FIG. 10, the NF 10 (e.g., the first NF) that has received the current prediction result may, if the CPU usage rate is 70% more according to an overload control guidance, allow only 50% of new messages subsequently transmitted from the second NF and block/reject the remaining messages, and if the CPU usage rate is changed to 70% or less, allow 1000% of new messages transmitted from the second NF again.

Next, a signaling control method (a communication technique between multiple NFs/NWDAFs) performed in an NF according to an embodiment of the present disclosure will be described.

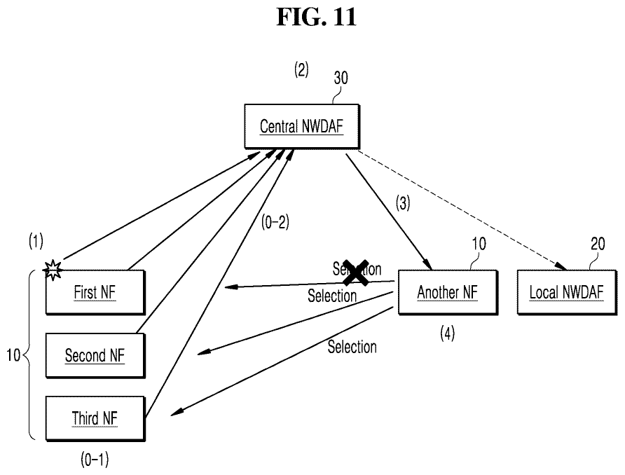

FIG. 11 to FIG. 16 are embodiments each showing a call flow according to a signaling storm state, which proceeds according to a signaling control method performed in an NF, that is, a communication technique between multiple NFs/NWDAFs according to the present disclosure.

Before the description, in FIGS. 11 to 16, although not illustrated for the sake of descriptive convenience, it should be understood that a new analytics ID for predicting an abnormal state (e.g., signaling storm) is used when messages are transmitted and received between an NF and an NWDAF and between an NWDAF and an NWDAF.

First, with reference to FIG. 11, in an embodiment, each NF 10 (the first, second or third NF) may predict/determine whether the NF is in an abnormal state, that is, in a signaling storm, through self-analysis (e.g., self AI/ML) by the NF (0-1).

In addition, each NF 10 (the first, second or third NF) may, periodically or as needed, measure/extract internal/external information of the NF and transfer same to an NWDAF (e.g., the central NWDAF 30) (0-2).

In this process, the first NF may autonomously predict/determine that the first NF is in an abnormal state, that is, a signaling storm, and transfer a request for analysis for the first NF and a result of predicting an abnormal state (e.g., signaling storm) to the central NWDAF 30 (1).

In this case, the central NWDAF 30 may analyze pieces of related information and perform an abnormal state (e.g., signaling storm) prediction procedure through internal analysis processing (e.g., AI/ML processing) to predict whether the first NF is in an abnormal state (e.g., signaling storm) (2).

Then, when it is predicted that the first NF is in an abnormal state, that is, a signaling storm, the central NWDAF 30 may transfer such an analysis result to the first NF, and/or may transfer a control request (e.g., Recommendation) to another NF (or the local NWDAF 20) related to the first NF (3), thereby inducing the signaling storm state in the first NF to be mitigated by an operation (e.g., excluding the first NF from selection targets) caused by the control request (e.g., Recommendation) (4).

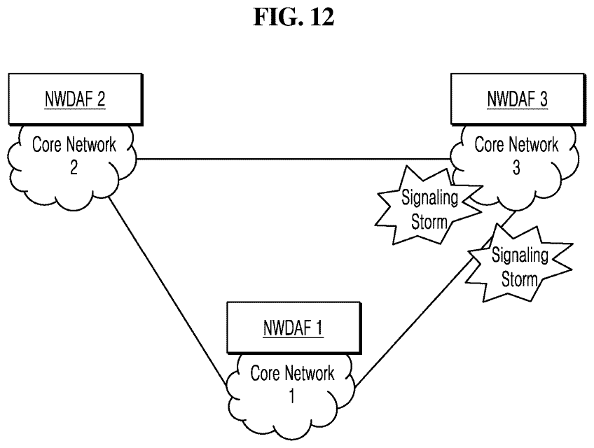

FIG. 12 shows a call flow between NWDAFs as an embodiment. NWDAF 1, 2, and 3 illustrated in FIG. 12 may each be a local NWDAF or central NWDAF.

As illustrated in FIG. 12, a communication technique between an NF and an NWDAF and a communication technique between multiple NFs/NWDAFs for analysis/prediction of a signaling storm according to the present disclosure may be also applied to a multi-core network environment (i.e., another network or a network having a different PLMN number).

For example, as illustrated in FIG. 12, each of NWDAFs 1, 2, and 3 may transmit and receive, to or from another NWDAF within a different network, information for analysis and prediction of an abnormal state (e.g., signaling storm) and/or a prediction result.

Therefore, if it is identified that a signaling storm for NWDAF 3 in Core network 3 has occurred, each of NWDAFs 1 and 2 may perform a subsequent procedure by using a method of lowering the traffic amount transferred to Core Network 3 or performing re-selection to prevent the transfer during a predetermined time.

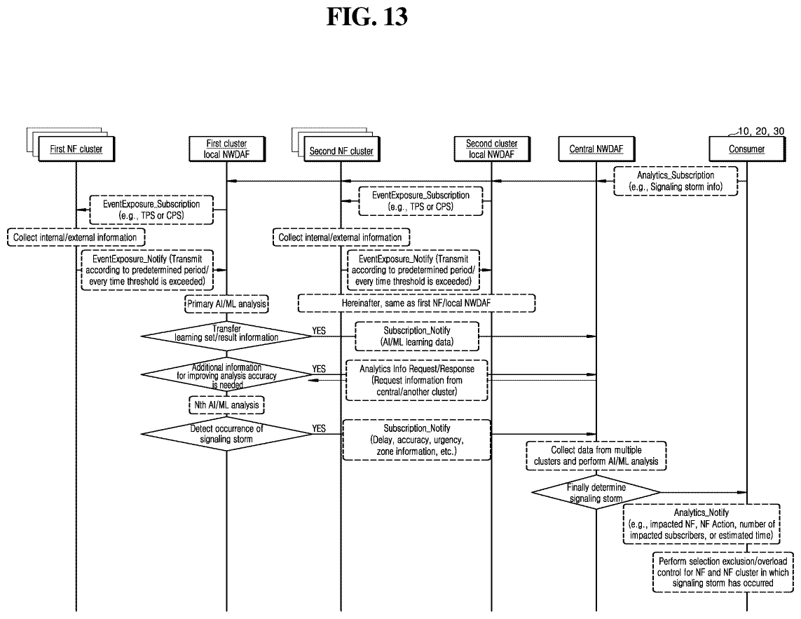

With reference to FIG. 13, in another embodiment, an NF (e.g., UENF, RANF, AMF, SMF, UPF, . . . , or another NWDAF) corresponding to a consumer may request a central NWDAF to transfer a prediction result for a particular NF (Analytics_Subscription, e.g., Signaling Storm Information Input).

The central NWDAF may request, from each local NWDAF (hereinafter, first and second cluster local NWDAFs), pieces of information (e.g., information to be used for analysis or an analysis/prediction result) required for performing an abnormal state prediction procedure for the particular NF requested by the consumer.

According to such a request from the central NWDAF, each of the first and second cluster local NWDAFs may obtain internal/external information from a first NF and a second NF belonging to respective clusters thereof (Subscription/Notify), and analyze the information to perform an abnormal state prediction procedure for the particular NF (primary AI/ML analysis).

Each of the first and second cluster local NWDAFs may, if it is determined that a prediction result (e.g., accuracy) of the current abnormal state prediction procedure is at a level indicating that the result is transferable to the central NWDAF, transfer the pieces of information having been used for the AI/ML analysis and the current prediction result (learning set/result information) to the central NWDAF (AI/ML learning data).

If it is determined that the prediction result is not at the level indicating that the result is transferable to the central NWDAF, each of the first and second cluster local NWDAFs may determine that additional information for improving analysis accuracy is needed, and request and obtain necessary additional information from another NWDAF, for example, the central NWDAF.

Each of the first and second cluster local NWDAFs may analyze even the obtained additional information to perform an abnormal state prediction procedure for the particular NF (nth AL/ML analysis).

If as a result of performing the abnormal state prediction procedure for the particular NF, the occurrence of an abnormal state, i.e., a signaling storm is recognized/detected, each of the first and second cluster local NWDAFs may transfer a prediction result according thereto (e.g., Signaling Storm Information OUTPUT) to the central NWDAF.

As illustrated in FIG. 13, each of the first and second cluster local NWDAFs may transfer delay, accuracy, urgency, zone information, etc. together when transferring the prediction result (e.g., Signaling Storm Information OUTPUT).

The central NWDAF may collect pieces of data (prediction result, delay, accuracy, urgency, zone information, etc.) from multiple clusters, that is, the first and second cluster local NWDAFs and autonomously perform AI/ML analysis to derive/determine a final prediction result for the particular NF and transfer same to the corresponding consumer (Analytics Notify, e.g., impacted NF, NF Action, the number of impacted subscribers, or an estimated time).

The corresponding consumer may perform a subsequent procedure such as selection exclusion/overload control for an NF and an NF cluster in which a signaling storm has occurred, according to the received final prediction result.

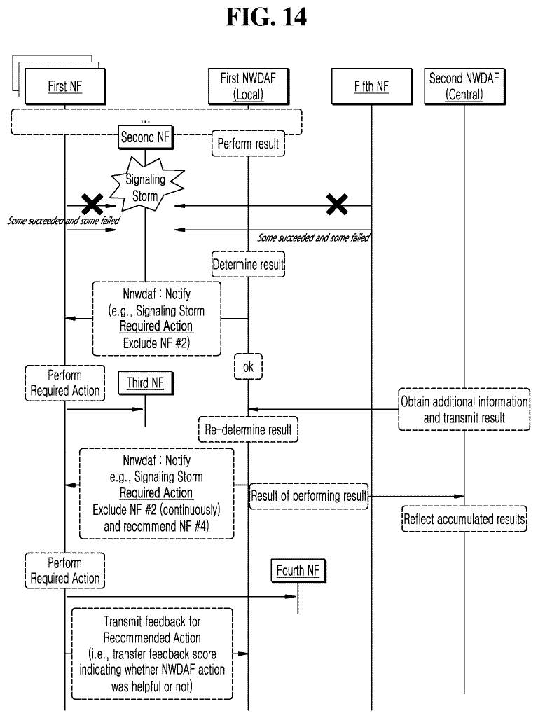

With reference to FIG. 14, in another embodiment, when an abnormal state, that is, a signaling storm, occurs in a second NF, other NFs communicating with the second NF, for example, first and fifth NFs may fail in a part of communication with the second NF.

In this case, a first NWDAF having predicted/determined whether an abnormal state, that is, a signaling storm has occurred, by performing an abnormal state prediction procedure for the second NF may transfer a prediction result for the second NF to the first NF within an area of the first NWDAF, and may provide information for excluding the second NF (NF #2) as a Required Action.

Accordingly, the first NF having received the current prediction result may communicate with another NF, for example, a third NF in replacement of the second NF by performing a subsequent procedure as the Required Action.

The first NWDAF may obtain additional information from another NWDAF, for example, a central NWDAF or may receive a prediction result for the second NF as a result of performance in the central NWDAF.

In this case, the first NWDAF may re-predict/determine whether an abnormal state, that is, a signaling storm has occurred in the second NF, transfer a prediction result thereof to the first NF, and the Required Action may be changed.

FIG. 14 illustrates an example of, as a Required Action, providing information for excluding the second NF (NF #2) and recommending a fourth NF (NF #4).

Accordingly, the first NF having received the current prediction result may communicate with the recommended fourth NF in replacement of the second NF by performing a subsequent procedure as the Required Action.

In this case, the first NF may, if necessary, transfer the completion level (feedback/reward score) of a result of the corresponding subsequent procedure (action) to the first NWDAF, and the first NWDAF may, based thereon, identify how well the action of the corresponding subsequent procedure has been performed and proceed in a closed-loop manner.

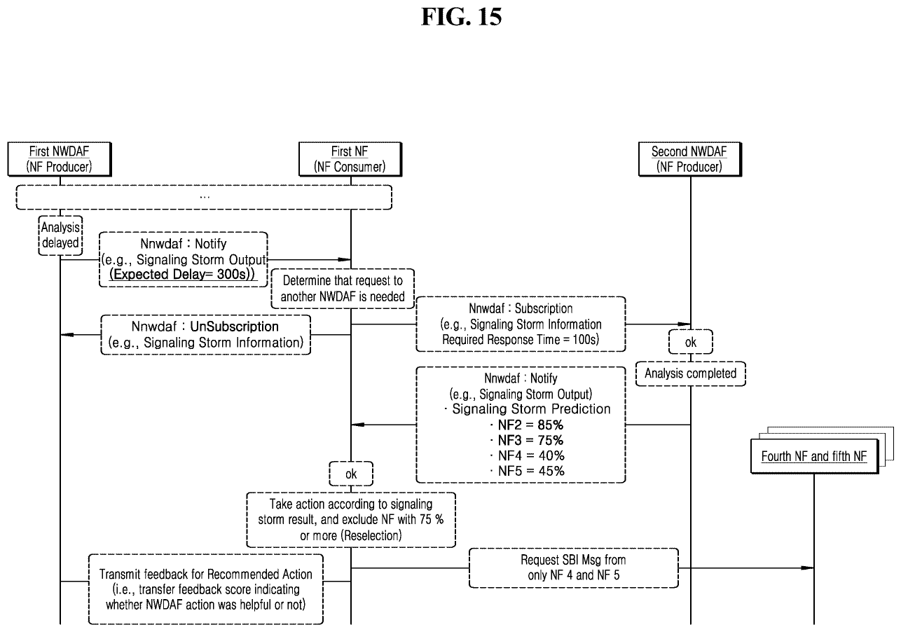

Next, another embodiment will be described with reference to FIG. 15.

FIG. 15 illustrates an embodiment in which a first NF as a consumer NF has requested a first NWDAF to analyze and predict whether an abnormal state (e.g., signaling storm) has occurred, and the first NWDAF transfers, to the first NF, information indicating that the transfer of a prediction result (e.g., signaling storm information OUTPUT) according to the analysis and prediction is being delayed (Expected Delay=300 s).

In this case, the first NF may determine that there is a need to transmit a re-request (re-commission) to an NWDAF other than the first NWDAF, and re-request a second NWDAF to analyze and predict whether an abnormal state (e.g., signaling storm) has occurred. The first NF may also transfer information (e.g., Required Response Time=100 s) on a time at which the first NF desires to receive a prediction result.

Then, the second NWDAF may perform an abnormal state prediction procedure according to the request from the first NF, and transfer, to the first NF, a prediction result (Recommended Action, e.g., Signaling Storm Prediction) obtained through analysis/prediction for an NF (e.g., NF 2, 3, 4, or 5).

In this case, the first NF may perform a subsequent procedure according to the received signaling storm prediction result to take an action of excluding NFs 2 and 3 having a Signaling Storm Prediction of 75% or more at the time of reselection and transferring an SBI message request to only NFs 4 and 5.

In this case, the first NF may, if necessary, transfer the completion level (feedback/reward score) of a result of the corresponding subsequent procedure (action) to the first NWDAF, and the first NWDAF may, based thereon, identify how well the action of the corresponding subsequent procedure has been performed and proceed in a closed-loop manner.

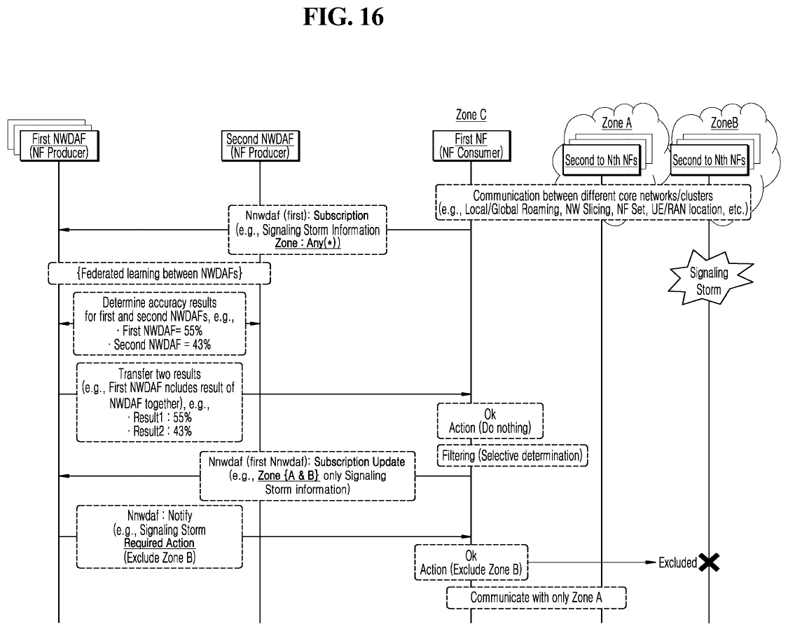

In addition, a communication technique between multiple NFs/NWDAFs according to the present disclosure may be applied in units of zones (analysis/prediction range) in communication between different core networks/clusters, and FIG. 16 illustrates an embodiment therefor.

FIG. 16 shows communication between different core network/clusters distinguished by local/global roaming, NW slicing, NF set, or UE/RAN location, and illustrates Zones A, B, and C accordingly.

In an embodiment of FIG. 16, a first NF belonging to Zone C may request a first NWDAF to analyze and predict whether an abnormal state (e.g., signaling storm) has occurred, and the request may be related to an unspecified zone (Zone: Any (*)).

In this case, the first NWDAF may obtain, through federated learning between NWDAFs, an analysis and prediction result of an abnormal state (e.g., signaling storm) prediction procedure performed by the first NWDAF and an analysis and prediction result of an abnormal state (e.g., signaling storm) prediction procedure performed by a federated second NWDAF, and the embodiment of FIG. 16 illustrates a situation where respective accuracies are determined to be 55% and 43%.

The first NWDAF may transfer the prediction results of the first NWDAF and the second NWDAF to the first NF (each of the first NWDAF and the second NWDAF may transfer the prediction result thereof to the first NF).

In this case, the first NF may not perform a separate subsequent procedure (action) according to a Required Action because the accuracies of the currently received prediction results are relatively low as 55% and 43%.

In this case, the first NF may re-request the first NWDAF to analyze and predict whether an abnormal state (e.g., signaling storm) has occurred, for a prediction result with higher accuracy and an appropriate subsequent procedure (action) if necessary, and the request may be performed by specifying a target zone (e.g., Zone {A & B}).

Accordingly, the first NWDAF may obtain, through federated learning between NWDAFs as described above, analysis and prediction results of an abnormal state (e.g., signaling storm) prediction procedure targeted only to Zones A and B, transfer same to the first NF, and provide, as a Required Action, information for excluding Zone B.

In this case, the first NF in Zone C having received the current prediction result may exclude NFs in Zone B from communication and communicate with only Zone A by performing a subsequent procedure as the Required Action.

As described above, according to a signaling control method performed in an NF of the present disclosure, a specific technical configuration enabling identification of and coping with the normality/abnormality of an NF (e.g., UENF, RANF, AMF, SMF, UPF, . . . ), a normal/abnormal operation between NFs, a signaling storm, and the like is implemented by implementing a communication technique between an NF and an NWDAF and a communication technique between multiple NFs/NWDAFs for defining a new analytics ID for predicting an abnormal state (e.g., signaling storm) between an NF and an NWDAF, and analyzing/predicting an abnormal state such as a signaling storm) by using the ID.

Accordingly, in the present disclosure, an effect of enabling detection of the abnormality of an NF, abnormal operations between NFs, and signaling storms, and optimally coping therewith, and an effect of avoiding degradation in communication and quality experienced by customers, which may be caused thereby, are derived.

A signaling control method according to an embodiment of the present disclosure may be implemented in a type of a program command that is performable through various computer means and recorded in a computer-readable medium. The computer-readable medium may include program commands, data files, and data structures alone or in combination. The program commands recorded on the medium may be specially designed and configured for the present disclosure, or may be well known and available to those skilled in the computer software art. Examples of the computer-readable recording medium include a magnetic medium such as a hard disk, a floppy disk, or a magnetic tape, an optical medium such as a compact disc-read only memory (CD-ROM) or a digital versatile disc (DVD), a magneto-optical medium such as a floptical disk, and a hardware device such as ROM, a random access memory (RAM), or a flash memory that is specially designed to store and execute program commands. Examples of the program commands include not only machine code generated by a compiler but also high-level language codes that may be executed by a computer using an interpreter or the like. The above hardware device may be configured to operate as one or more software modules to perform an operation of the present disclosure, and vice versa.

Although the present disclosure has been described in detail in connection with various embodiments, the present disclosure is not limited to the above-described embodiments. It will be apparent to those skilled in the art that various changes and modifications may be made without departing from the scope of the present disclosure as defined in the appended claims.

1. A network function (NF) device comprising:
a memory comprising an instruction; and
a processor configured to execute the instruction to transfer information to be used for analysis to an NF (network data analytics function (NWDAF)) configured to perform an abnormal state prediction procedure through information analysis, to request a prediction result obtained by performing the abnormal state prediction procedure,
wherein the processor is configured to select a particular NWDAF from among multiple NWDAFs according to the information to be transferred and transfer the information to the particular NWDAF.

2. The NF device of claim 1, wherein the processor is configured to select the particular NWDAF, based on at least one of whether the information to be transferred is real-time data or non-real-time data, an estimated processing time consumed for analyzing the information, and a capacity required for analyzing the information.

3. The NF device of claim 1, wherein the multiple NWDAFs comprise a first NWDAF close (local) to the NF device and a second NWDAF configured to perform an abnormal state prediction procedure by interworking with multiple first NWDAFs.

4. The NF device of claim 1, wherein the processor is configured to, when receiving, from the particular NWDAF, a prediction result of an abnormal state prediction procedure performed through analysis of the transferred information, additionally request a prediction result from another NWDAF among the multiple NWDAFs according to the prediction result.

5. The NF device of claim 4, wherein the processor is configured to:
perform a subsequent procedure according to the prediction result transferred from the particular NWDAF or the other NWDAF; and
when performing of the subsequent procedure is determined to be impossible, re-request, from the particular NWDAF or the other NWDAF, a prediction result for performing an alternative subsequent procedure.

6. A network data analytics function (NWDAF) device comprising:
a memory comprising an instruction; and
a processor configured to execute the instruction to derive a prediction result by performing an abnormal state prediction procedure related to a particular NF through analysis of information transferred from each NF, and transfer information to another NWDAF or request additional information from another NWDAF according to the prediction result.

7. The NWDAF device of claim 6, wherein the processor is configured to control information transfer to the other NWDAF by using, as a criterion, at least one of accuracy, impact, and urgency for the prediction result.

8. The NWDAF device of claim 6, wherein the processor is configured to:
according to the prediction result, transfer information to the other NWDAF to allow the information to be used in an abnormal state prediction procedure for deriving a final prediction result for the particular NF, the abnormal state prediction procedure being performed by the other NWDAF; or
according to the prediction result, request additional information from the other NWDAF, and derive a final prediction result by re-performing the abnormal state prediction procedure in which even the additional information is analyzed.

9. The NWDAF device of claim 6, wherein the other NWDAF is a centralized NWDAF configured to perform an abnormal state prediction procedure by interworking with multiple local NWDAFs.

10. A signaling control method performed in a network function (NF), the method comprising transferring information to be used for analysis to an NF (network data analytics function (NWDAF)) configured to perform an abnormal state prediction procedure through information analysis, to request a prediction result obtained by performing the abnormal state prediction procedure,
wherein the transferring comprises selecting a particular NWDAF from among multiple NWDAFs according to the information to be transferred and transferring the information to the particular NWDAF.

11. A signaling control method performed in a network data analytics function (NWDAF), the method comprising:
deriving a prediction result by performing an abnormal state prediction procedure related to a particular NF through analysis of information transferred from each NF; and
transferring information to another NWDAF or requesting additional information from another NWDAF according to the prediction result.
